(19) United States
(12) Patent Application Publication
(10) Pub. No.: US 2025/0340234 A1
(43) Pub. Date: Nov. 6, 2025

(54) LIFT CARTS FOR CARGO HANDLING

(71) Applicant: Robert Wei, West Linn, OR (US)

(72) Inventor: Robert Wei, West Linn, OR (US)

(21) Appl. No.: 19/194,899

(22) Filed: Apr. 30, 2025

Related U.S. Application Data
(60) Provisional application No. 63/642,396, filed on May 3, 2024.

(51) Int. Cl. B62B 3/06; B65G 67/02; B66F 7/06

(52) U.S. Cl. CPC B62B 3/0643; B62B 3/0612; B65G 67/02; B66F 7/065; B62B 2203/70

(57) ABSTRACT

Lift carts for cargo including a wheeled platform, an extension assembly, and a lift assembly. In some examples, the lift carts include a controller controllably coupled to the lift assembly. The extension assembly is mounted to the wheeled platform and configured to translate the wheeled platform horizontally. The lift assembly is mounted to the extension assembly and configured to raise the extension assembly and the wheeled platform mounted to the extension assembly. In examples with a controller, the controller is configured to selectively activate the lift assembly to raise the extension assembly and the wheeled platform. The wheeled platform, the extension assembly, and the lift assembly cooperate to move the lift cart from a lower surface onto an elevated surface. The wheeled platform, the extension assembly, and the lift assembly cooperate to move the lift cart from an elevated surface to a lower surface.

### CROSS REFERENCE TO RELATED APPLICATIONS

This application claims priority to copending U.S. Application, Ser. No. 63/642,396, filed on May 3, 2024, which is hereby incorporated by reference for all purposes.

### BACKGROUND

The present disclosure relates generally to carts. In particular, lift carts to facilitate cargo handling are described.

Loading and unloading cargo is a task undertaken countless times a day in various industries and in personal contexts. Cargo is often heavy and awkward, which makes loading or unloading it challenging. Adding further challenges is the need to load or unload cargo from a vehicle with a raised cargo area, such as a pickup truck or delivery truck.

Wheeled carts exist to ease the burden of moving cargo along the ground. Some conventional wheeled carts have lift mechanisms enabling a platform to be raised to facilitate lifting cargo.

Known lift carts are not entirely satisfactory. For example, conventional lift carts lack means to slide the cart forward into a cargo hold from a lifted position. In addition, conventional lift carts are not configured to move themselves entirely into elevated cargo holds. A lift cart that could completely move up into an elevated cargo hold would provide multiple benefits.

For example, a lift cart configured to move itself into an elevated cargo hold would enable the lift cart to be easily transported with the cargo. Transporting the lift cart with the cargo would allow the lift cart to be available at a destination to assist with unloading the cargo. Further, a lift cart configured to fully step up into an elevated cargo hold would dispense with the need to transfer the cargo off the lift cart onto a surface of the cargo hold. Instead, the cargo could remain on the lift cart in the cargo hold as the vehicle travels to a destination where the cargo is to be unloaded.

Thus, there exists a need for novel lift carts that improve upon and advance the design of known lift carts. Examples of new and useful lift carts relevant to the needs existing in the field are discussed below.

### SUMMARY

The present disclosure is directed to lift carts for cargo. The lift carts include a wheeled platform, an extension assembly, and a lift assembly. In some examples, the lift carts include a controller controllably coupled to the lift assembly.

The extension assembly is mounted to the wheeled platform and configured to translate the wheeled platform horizontally. The lift assembly is mounted to the extension assembly and configured to raise the extension assembly and the wheeled platform mounted to the extension assembly. In examples with a controller, the controller is configured to selectively activate the lift assembly to raise the extension assembly and the wheeled platform.

The wheeled platform, the extension assembly, and the lift assembly cooperate to move the lift cart from a lower surface onto an elevated surface and also cooperate to move the lift cart from an elevated surface to a lower surface.

### BRIEF DESCRIPTION OF THE DRAWINGS

FIG. 1 is a perspective view of a first example of a lift cart in a nested and retracted configuration.

FIG. 2 is a perspective view of the lift cart shown in FIG. 1 in a nested and raised configuration.

FIG. 3 is a perspective view of the lift cart shown in FIG. 1 in an extended and raised configuration.

FIG. 4 is a side elevation view of the lift cart shown in FIG. 1 in the nested and retracted configuration behind a pickup truck bed with cargo on a platform.

FIG. 5 is a side elevation view of the lift cart shown in FIG. 1 in the nested and raised configuration behind the pickup truck bed with cargo on the platform.

FIG. 6 is a side elevation view of the lift cart shown in FIG. 1 in the extended and raised configuration with the wheeled platform in the truck bed and the lift assembly supported on the ground behind the pickup truck bed.

FIG. 7 is a side elevation view of the lift cart shown in FIG. 1 in the extended and retracted configuration with the wheeled platform in the truck bed and the lift assembly raised off the ground behind the pickup truck bed.

FIG. 8 is a side elevation view of the lift cart shown in FIG. 1 in the nested and retracted configuration fully within the pickup truck bed.

FIG. 9 is a front elevation view of the lift cart shown in FIG. 1 in the nested and retracted configuration.

FIG. 10 is a front elevation view of the lift cart shown in FIG. 1 in the nested and raised configuration.

FIG. 11 is a view of a controller of the lift cart shown in FIG. 1 including a switch for selectively activating the lift assembly to move between the retracted and raised configurations.

### DETAILED DESCRIPTION

The disclosed lift carts will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various lift carts are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

### Contextual Details

Ancillary features relevant to the lift carts described herein will first be described to provide context and to aid discussing the lift carts.

### Cargo Holds

The lift carts disclosed herein are often used to load cargo into cargo holds and to unload cargo from cargo holds. A wide variety of cargo holds are suitable for use with the novel lift carts discussed in this document. The cargo holds may be associated with a vehicle or may be part of a structure.

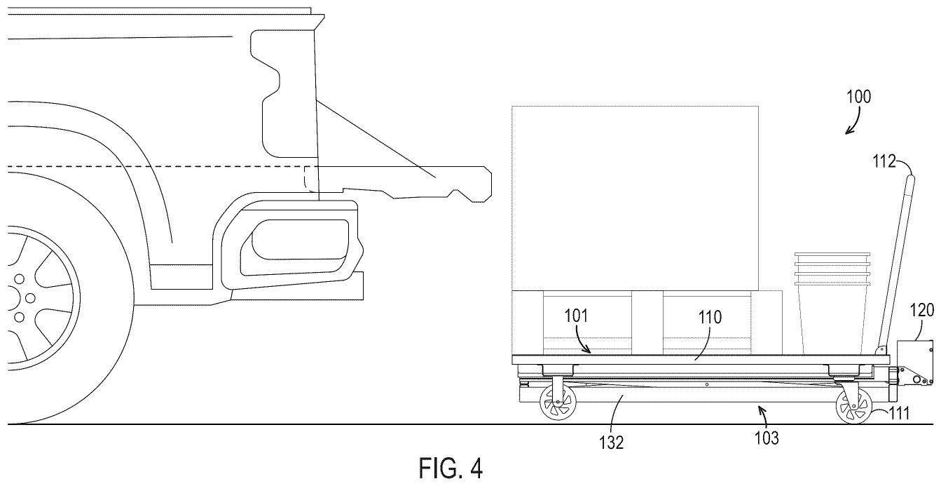

For example, the cargo hold may be the bed of a pickup truck like shown in FIGS. 4-8. Other vehicle-related cargo holds include flatbed trucks, open trailers, and enclosed trailers. Alternatively, the cargo hold may be a shelf or other structure in a room or building, such as a garage, a warehouse, or a retail store.

In many instances, the cargo hold is elevated off the ground. The height of the cargo hold will vary, and the lift carts described below can be configured to work with a wide variety of cargo hold heights.

### Lift Carts for Cargo Handling

With reference to the figures, novel lift carts for cargo handling will now be described. The novel lift carts discussed herein function to facilitate handling cargo by providing a platform that rolls along the ground, lifts to elevated cargo holds, and extends into the elevated cargo hold. Further, the novel lift carts are configured to move entirely into elevated cargo holds.

The reader will appreciate from the figures and description below that the presently disclosed lift carts address many of the shortcomings of conventional lift carts. For example, the novel lift carts described herein provide means to slide a cargo carrying platform forward into a cargo hold from a lifted position. In addition, the novel lift carts are configured to step entirely up to elevated cargo holds.

The ability of the novel lift carts to move themselves completely up into an elevated cargo hold provides multiple benefits. For example, the novel lift carts moving themselves into an elevated cargo hold enables them to be easily transported with the cargo. Transporting the lift carts with the cargo makes them available to assist with unloading the cargo at the final destination for the cargo.

Further, the novel lift carts being configured to fully step up into an elevated cargo hold dispenses with the need to transfer the cargo off the novel lift carts onto a surface of the cargo hold. Instead, the cargo can conveniently remain on the novel lift cart in the cargo hold as the vehicle travels to a destination where the cargo is to be unloaded.

### Lift Cart Embodiment One

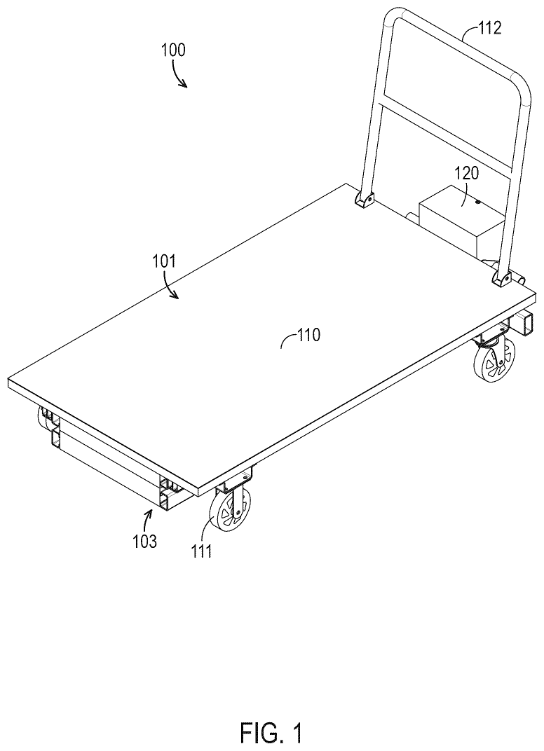

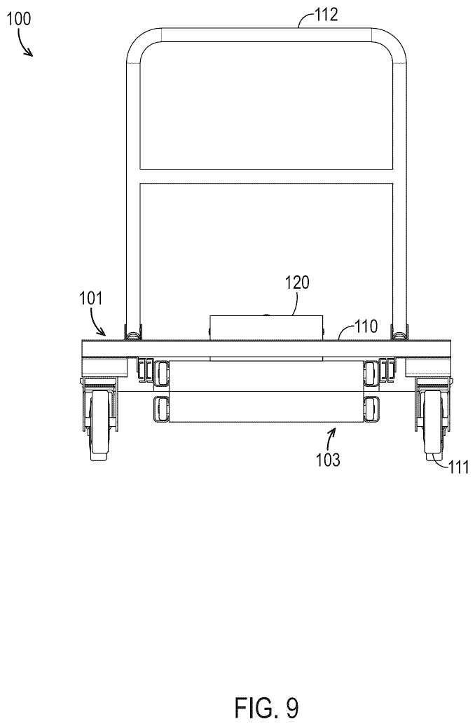

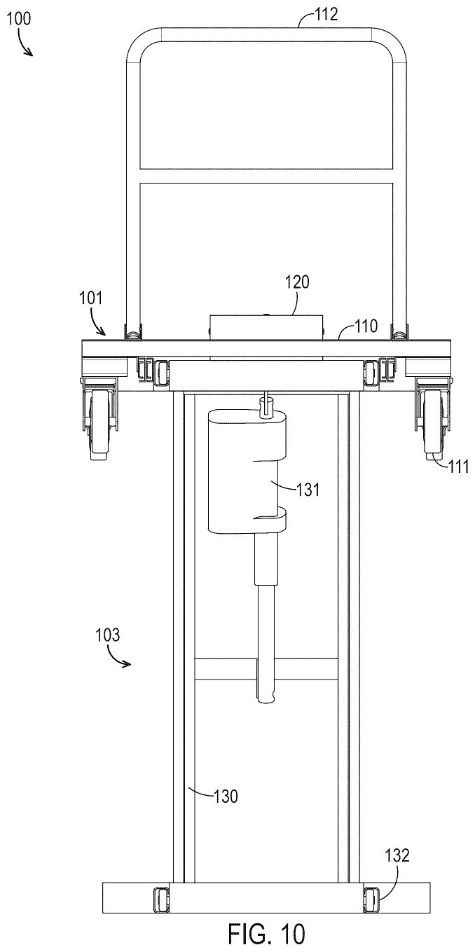

With reference to FIGS. 1-11, a first example of a lift cart, lift cart 100, will now be described. In the present example, lift cart 100 includes a wheeled platform 101, an extension assembly 102, a lift assembly 103, and a controller 120. The components of lift cart 100 are described in more detail in the sections below.

In some examples, the lift cart includes fewer, additional, or alternative components than included in lift cart 100. For example, some lift cart examples do not include a controller integrated into the lift cart and may be controllably coupled to a separate computer or handheld device. Some lift cart examples include horizontal actuators, speakers, and lights.

As is apparent in the views shown in FIGS. 1-10, lift cart 100 is configured to selectively raise and lower. Further, lift cart 100 is configured to selectively extend and retract horizontally.

As shown in FIGS. 4-8, lift cart 100 selectively lifting and translating horizontally allows lift cart 100 to move itself from a ground level position into an elevated cargo hold. Lift cart 100 is also configured to move itself from an elevated cargo hold to a ground level position. Notably, lift cart 100 is configured to move itself entirely between the ground and an elevated cargo hold while supporting cargo loaded onto it.

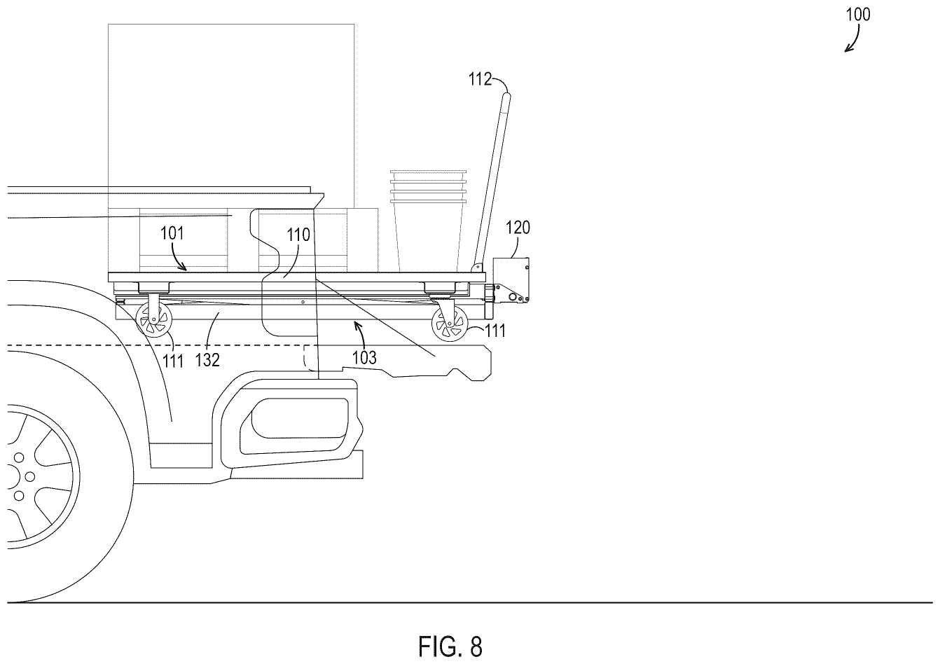

With reference to FIGS. 4-8, a sequence of steps undertaken by lift cart 100 to move from ground level to a cargo hold will be described. Lift cart 100 is shown in a ground level position in FIG. 4 and in a cargo hold in FIG. 8.

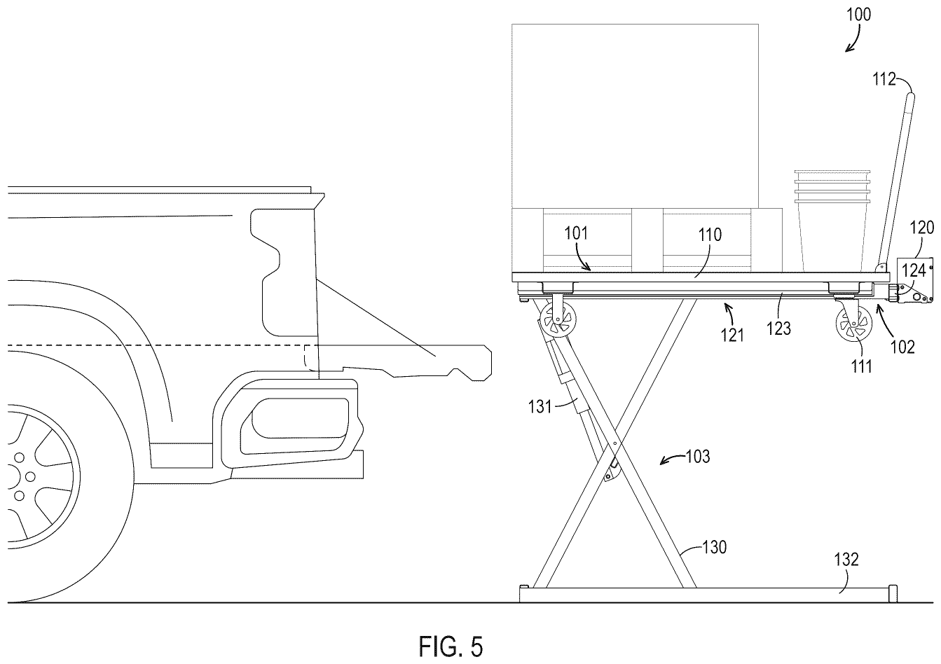

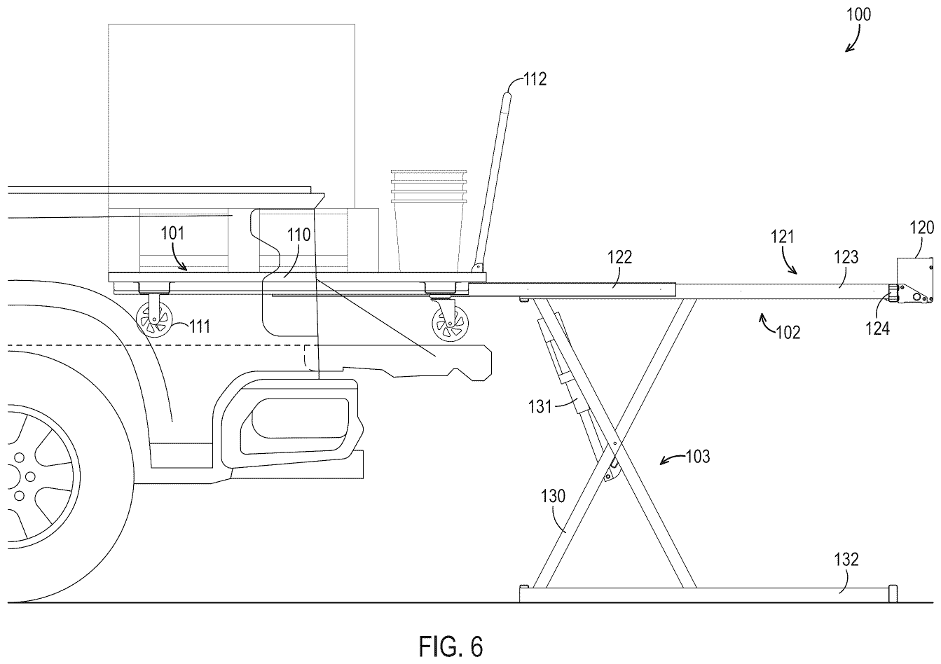

As shown in FIGS. 4 and 5, lift cart 100 first lifts up wheeled cart 101 to the height of the cargo hold with lift assembly 103. Next, as demonstrated in FIG. 6, extension assembly 102 is manually extended to translate wheeled cart 101 into the cargo hold. Wheeled cart 101 is configured to lock its wheels to remain stationary within the cargo hold and to support lift cart 100 from the cargo hold.

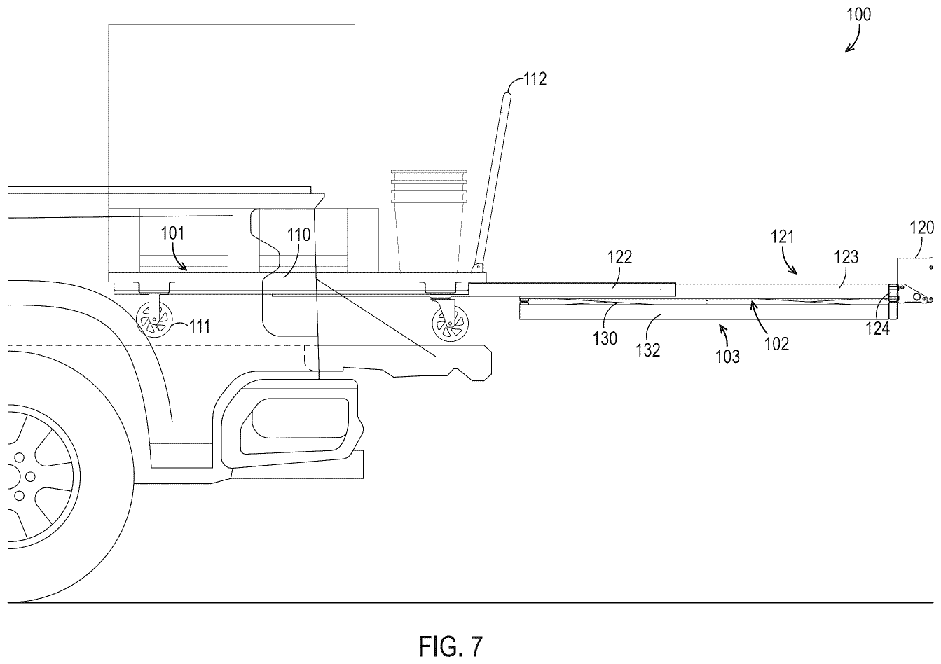

As shown in FIG. 7, when wheeled cart 101 is stably positioned within the cargo hold, lift assembly 103 raises itself off the ground to a nested position proximate extension assembly 102 at the height of the cargo hold. Finally, as apparent in FIG. 8, extension assembly 102 is manually retracted to translate lift assembly 103 underneath wheeled cart 101, which results in lift cart 100 being disposed entirely within the cargo hold.

To move from the cargo hold to ground level, lift cart 100 undertakes a reverse sequence of steps depicted in FIGS. 8-4. As shown in FIGS. 8 and 7, extension assembly 102 is first manually extended to translate lift assembly 103 horizontally out from below wheeled cart 101 beyond the cargo hold to a position above the ground. With reference to FIG. 6, lift assembly 103 then extends down to ground level to support lift cart 100 from the ground. Next, as depicted in FIG. 5, the brakes on the wheels of wheeled cart 101 are released and extension assembly 102 is manually retracted to horizontally translate wheeled cart 101 to a position overlying lift assembly 103. Finally, as shown in FIG. 4, lift assembly 103 lowers wheeled assembly 101 and extension assembly 102 to the ground.

Lift cart 100 is configured to move from a self-contained configuration, a vertically extended and a horizontally retracted configuration, a vertically extended and a horizontally extended configuration, a vertically retracted and horizontally extended configuration, and back to the self-contained configuration. The reverse sequence of configurations is also possible. Further possible is lift cart 100 moving between a subset of the configurations. For example, lift cart 100 may horizontally extend and retract without vertically extending or retracting. Alternatively, lift cart 100 may vertically extend and retract without horizontally extending or retracting.

FIGS. 1, 4, 8, and 9 demonstrate the self-contained configuration of lift cart 100. As shown in the views depicted in FIGS. 1, 4, 8, and 9, extension assembly 102 and lift assembly 103 are disposed underneath wheeled cart 101 and spaced from the ground or floor in the self-contained configuration. In the self-contained configuration, extension assembly 102 is retracted and lift assembly 103 is also retracted.

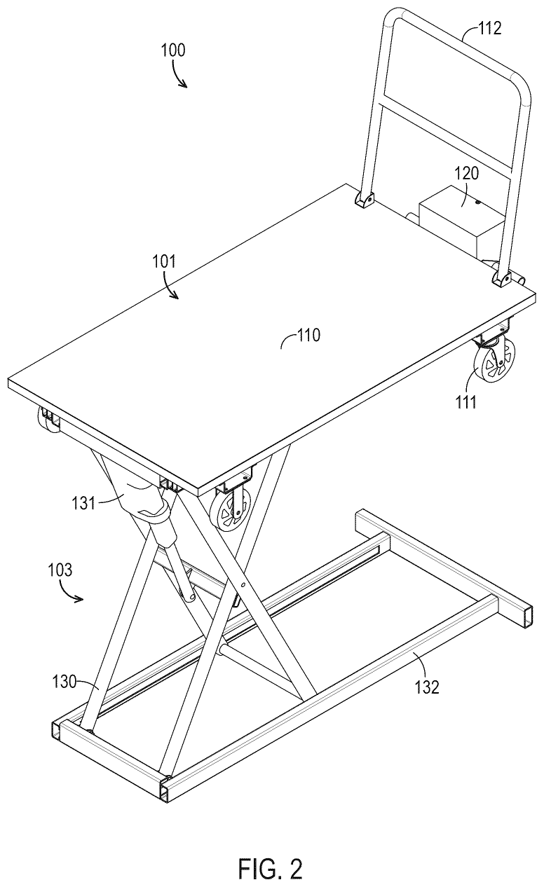

FIGS. 2, 5, and 10 demonstrate the vertically extended and horizontally retracted configuration of lift cart 100. As shown in the views depicted in FIGS. 2, 5, and 10, wheeled cart 101 is raised off the ground or floor by lift assembly 103 in the vertically extended and horizontally retracted configuration. In the vertically extended and horizontally retracted configuration, extension assembly 102 is retracted and wheeled cart 101 overlies lift assembly 103.

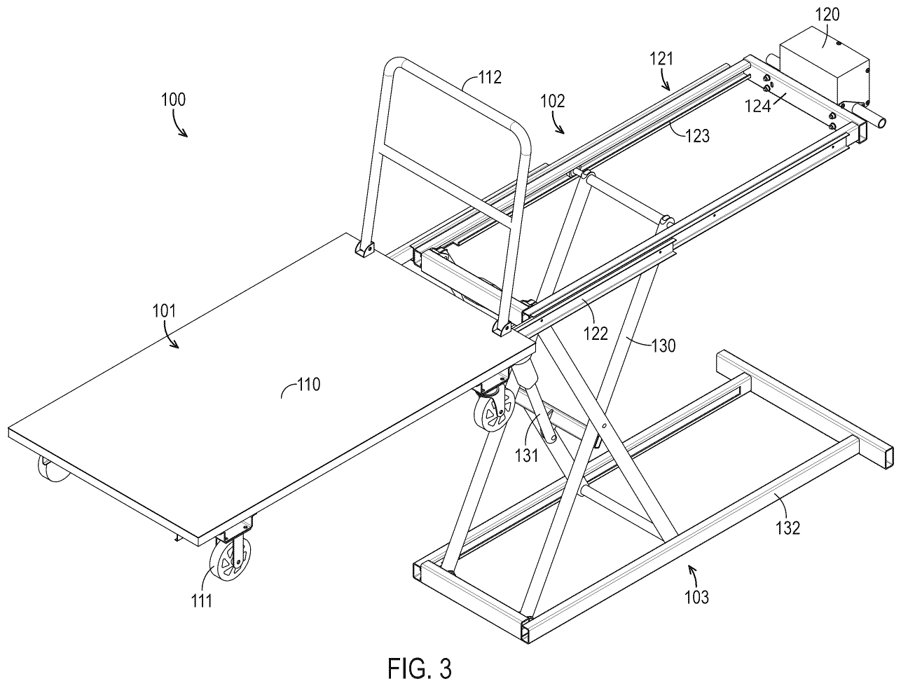

FIGS. 3 and 6 demonstrate the vertically extended and horizontally extended configuration. As shown in the views depicted in FIGS. 3 and 6, wheeled cart 101 is raised off the ground or floor by lift assembly 103 and extended forward by extension assembly 102 in the vertically extended and horizontally extended configuration. In the vertically extended and horizontally extended configuration, extension assembly 102 is extended and wheeled cart 101 is horizontally offset from lift assembly 103.

### Wheeled Cart

Wheeled cart 101 functions to support cargo while stationary or moving. In stationary contexts, wheeled cart 101 supports cargo from the ground or a floor of a cargo hold. In moving contexts, wheeled cart 101 is configured to support cargo while rolling along the ground or a floor of a cargo hold. Further, wheeled cart 101 also supports cargo when translated up and down by lift assembly 103 and when translated forward and back by extension assembly 102.

As can be seen in FIGS. 1-10, wheeled cart 101 includes a platform 110, wheels 111, and a handle 112. Wheels 111 moveably support platform 110 from the ground or a floor of a cargo hold. Handle 112 is mounted to platform 110.

FIGS. 4-8 demonstrate that platform 110 supports cargo placed on it. As shown in FIGS. 1-10, extension assembly 102 is coupled to platform 110. In particular, as shown in FIGS. 3, 6, 9 and 10, extension assembly 102 mounts to an underside of platform 110. The height of wheels 111 is selected to space extension assembly 102 off the ground underneath platform 110. As described further below, lift assembly 103 is coupled to extension assembly 102 and is also spaced from the ground underneath platform 110 when lift cart 100 is in the self-contained configuration depicted in FIGS. 1, 3, 8, and 9.

The wheels may be any type of wheel or caster currently known or later developed suitable for cart applications. In the present example, the wheels include a brake to selectively restrict the wheels from rolling. The brakes may be selectively engaged when wheeled cart 101 is in a cargo hold to allow wheeled cart to serve as an anchor or support platform. Wheeled cart 101 serving as an anchor or support platform facilitates lift assembly 103 and extension assembly 102 moving when lift assembly 103 is off the ground.

The platform may be any size, shape, and material suitable for supporting cargo. In the present example, platform 110 is formed from metal, but may be formed from wood, polymers, and composite materials in other examples.

The handle may be any type and configuration suitable for manually maneuvering the platform supported on the wheels. The handle may be larger or smaller than depicted in FIGS. 1-10.

### Extension Assembly

Extension assembly 102 functions to selectively translate wheeled cart 101 in a horizontal plane between a nested position and an extended position. Extension assembly 102 translates wheeled cart 101 relative to lift assembly 103. The relative translation enabled by extension assembly 102 functions in reverse as well. For example, comparing FIGS. 7 and 8, extension assembly 102 functions to pull lift assembly 103 towards wheeled cart 101 when wheeled cart 101 is anchored in position and lift assembly 103 is in a vertically retracted position.

In the example shown in FIGS. 1-10, extension assembly 102 is manually moved between the nested and extended positions. In particular, a user may manually move nested rail 121 between the nested and extended positions. In some examples, the extension assembly includes a horizontal actuator operable to selectively extend and retract the nested rail between the nested and extended positions.

The horizontal actuator may be any currently known or later developed type of actuator, including screw drive mechanisms, pneumatic and hydraulic cylinders, and electromagnetic actuators. The size, strength, and extension range of the horizontal actuator may be selected accommodate a given wheeled cart size, shape, and weight, including the weight of anticipated cargo to be supported on the wheeled cart.

As shown in FIGS. 3, 6, 9, and 10, extension assembly 102 includes a nested rail 121. FIGS. 3 and 6 demonstrate that nested rail 121 includes moveable rail members 122, fixed rail members 123, and a frame 124. Fixed rail members 123 mount to frame 124.

In the nested position depicted in FIGS. 1, 2, 4, 5, and 8, moveable rail members 122 are nested within fixed rail members 123 to decrease the effective length of nested rail 121 to approximately the length of fixed rail members 123. The length of fixed rail members 123 are complementarily configured with a length of wheeled cart 101 such that nested rail 121 substantially underlies wheeled cart 101 in the nested position.

In the extended position shown in FIGS. 3, 6, and 7, moveable rail members 122 are extended from fixed rail members 123. Moveable rail members 122 being extended from fixed rail members 123 increases the effective length of nested rail 121.

As shown in FIGS. 3, 6, 7, 9, and 10, wheeled cart 101 is mounted to moveable rail members 122. Accordingly, when moveable rail members 122 are extended beyond fixed rail members 123, wheeled cart 101 translates relative to fixed rail members 123 as well. In the present example, extending moveable rail members 122 translates wheeled cart 101 to a position horizontally offset from lift assembly 103.

As shown in FIGS. 3 and 6, lift assembly 103 is coupled to frame 124. When lift cart 100 is in vertically extended configurations, lift assembly 103 supports extension assembly 102 from the ground. When lift cart 100 is in the self-contained configuration or when lift assembly 103 is retracted away from the ground, wheels 111 of wheeled cart 101 support extension assembly 102 from a support surface, such as from a bed of a pickup truck as shown in FIGS. 7 and 8. As shown in FIGS. 3 and 6, lift assembly 103 supports extension assembly 102 from a position near the middle of the effective length of nested rail 121 when extension assembly 102 is in a horizontally extended configuration to promote balance and stability when lift assembly 103 supports lift cart 100 from the ground.

### Lift Assembly

Lift assembly 103 serves to selectively lift extension assembly 102 and wheeled cart 101, including cargo supported on wheeled cart 101. Lift assembly 103 further functions to pull itself up to the height of wheeled cart 101 when wheeled cart 101 is disposed in a cargo hold. Lift assembly 103 pulling itself up to the height of wheeled cart 101 contributes to lift cart 100 being capable of moving itself fully into the cargo hold.

In the example shown in FIGS. 1-10, lift assembly 103 is a scissor lift including scissor legs 130, a vertical actuator 131, and a base 132. As depicted in FIGS. 4-6, base 132 supports scissor legs 130 and vertical actuator 131 from the ground when operating to lift wheeled cart 101 and extension assembly 102. Scissor legs 130 are pivotally coupled to base 132 and configured to selectively raise and lower when driven by vertical actuator 131.

Vertical actuator 131 is configured to both extend and retract to correspondingly raise and lower scissor legs 130. Vertical actuator is controllably coupled to controller 120. User input to controller 120 causes vertical actuator 131 to selectively extend and retract scissor legs 130 to correspondingly raise and lower scissor legs 130. In particular, a user pressing switch 125 of controller 120 upwards instructs vertical actuator 131 to extend scissor legs 130 and pressing switch 125 downwards instructs vertical actuator 131 to retract scissor legs 130.

In the present example, vertical actuator 131 is a hydraulic cylinder. However, the vertical actuator may be any currently known or later developed type of actuator. Suitable actuators include screw drive mechanisms, pneumatic cylinders, hydraulic cylinders, and electromagnetic actuators.

The scissor legs may be configured to extend to a wide range of heights, including taller heights than depicted in FIGS. 2, 3, 5, 6, and 10. Preferred lifting heights will correspond with typical heights of cargo holds, such as the height of a pickup truck bed like shown in FIGS. 4-8, a delivery truck bed, a shelf, or a loading dock.

### Controller

Controller 120 functions to control operation of vertical actuator 131; namely, selectively causing vertical actuator 131 to extend and retract scissor legs 130. In lift cart examples including a horizontal actuator, the controller may control operation of the horizontal actuator as well.

The controller is an optional feature of the lift carts described herein. In some examples, the lift carts are controlled by a separate device, such as a remote control, a computer, or a handheld electronic device.

Controller 120 depicted in FIGS. 1-11 is just one example of a suitable controller. Other controller examples may include fewer, additional, or alternative features. For example, some controller examples include different inputs, including buttons, switches, toggles, and sliders. Some controller examples include computer displays, touchscreens, and/or computer peripherals like a mouse and keyboard.

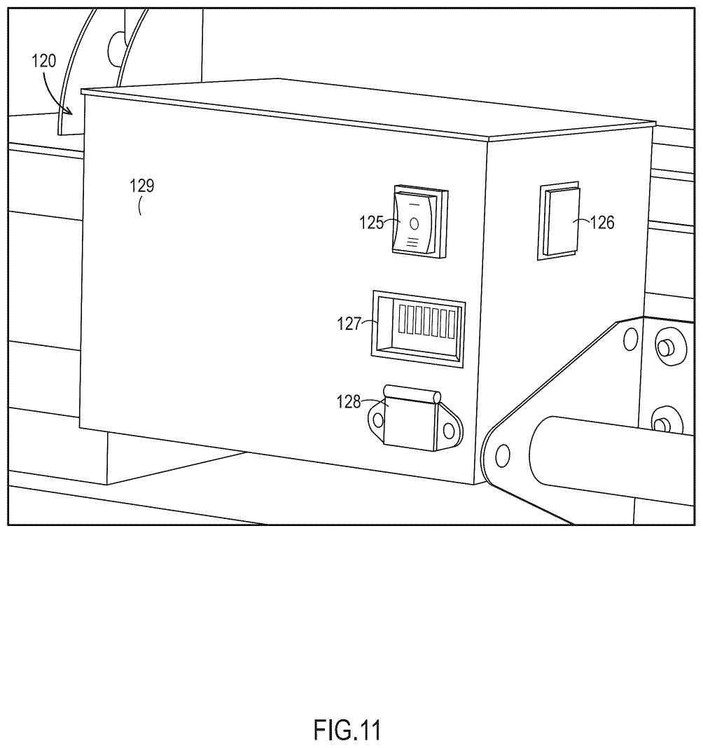

With reference to FIG. 11, the reader can see that controller 120 includes a vertical actuator switch 125, a power switch 126, a battery level indicator 127, a charging port 128, and a housing 129. Other controller examples may include fewer, additional, or alternative components.

Housing 129 contains electronic components, including a battery. Vertical actuator switch 125, power switch 126, battery level indicator 127, and charging port 128 are mounted to housing 129.

Vertical actuator switch 125 controls operation of vertical actuator 131; namely, causing vertical actuator 130 to selectively extend and retract scissor legs 130. Power switch 126 selectively activates controller 120. Battery level indicator 127 displays a current charge level of a battery supplying power to lift cart 100. Charging port 128 receives a complementary charging cable to recharge the battery from a power source as needed.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A lift cart for cargo, comprising:
a wheeled platform;
an extension assembly mounted to the wheeled platform and configured to translate the wheeled platform horizontally; and
a lift assembly mounted to the extension assembly and configured to raise the extension assembly and the wheeled platform mounted to the extension assembly;
wherein:
the wheeled platform, the extension assembly, and the lift assembly cooperate to move the lift cart from a lower surface onto an elevated surface; and
the wheeled platform, the extension assembly, and the lift assembly cooperate to move the lift cart from an elevated surface to a lower surface.

2. The lift cart of claim 1, wherein:
the wheeled platform includes:
a platform having a bottom side and lateral sides; and
wheels mounted to the platform proximate the lateral sides and extending below the bottom side to a support surface;
the wheeled platform defines an undercarriage space between the bottom side and the support surface;
the extension assembly moves between a nested position and an extended position;
the extension assembly mounts to the bottom side of the platform, is spaced from the support surface; and is contained within the undercarriage space when in the nested position.

3. The lift cart of claim 2, wherein the extension assembly is configured to be manually moved between the nested configuration and the extended configuration by pressing or pulling on the wheeled platform or the extension assembly.

4. The lift cart of claim 2, wherein:
the lift assembly moves between a retracted position and a raised position; and
the lift assembly is spaced from the support surface and contained within the undercarriage space when in the retracted position.

5. The lift cart of claim 4, wherein the wheeled platform rolls on the wheels unimpeded by the lift assembly or the extension assembly when the lift assembly is in the retracted position.

6. The lift cart of claim 4, wherein the extension assembly is configured to translate the wheeled platform horizontally when the lift assembly is in the raised position.

7. The lift cart of claim 4, wherein the lift assembly is configured to move from the raised position to the retracted position when the extension assembly is spaced above a lower surface and supported by the wheeled platform resting on an elevated surface.

8. The lift cart of claim 2, wherein the extension assembly includes a rail mounted to the bottom side of the platform.

9. The lift cart of claim 8, wherein the rail is nested and includes:
a fixed rail mounted to the lift assembly; and
a movable rail movably mounted to the fixed rail and fixedly mounted to the bottom side of the platform.

10. The lift cart of claim 9, wherein the moveable rail selectively extends beyond the fixed rail when the extension assembly moves from the nested position to the extended position.

11. The lift cart of claim 2, wherein the extension assembly is configured to move from the nested position to the extended position overlying and vertically spaced from a lower surface when the wheeled platform is resting on an elevated surface.

12. The lift cart of claim 11, wherein the lift assembly is in the retracted position when the extension assembly moves from the nested position to the extended position overlying and vertically spaced from a lower surface and the wheeled platform is resting on an elevated surface.

13. The lift cart of claim 1, wherein the lift assembly is a scissor lift.

14. The lift cart of claim 13, wherein the lift assembly includes:
a base configured to support the lift assembly from a support surface;
scissor legs pivotally mounted to the base and to the extension assembly; and
an actuator drivingly mounted to the scissor legs and configured to vertically raise and retract the scissor legs.

15. The lift cart of claim 1, wherein the extension assembly is configured to translate the wheeled platform horizontally when the lift assembly has raised the wheeled platform above a lower surface to be level with an upper surface.

16. The lift cart of claim 1, wherein the wheeled platform includes:
a platform;
wheels mounted to the platform and supporting the platform from a support surface; and
a brake configured to selectively restrict at least one of the wheels from moving to restrict the wheeled platform from moving.

17. The lift cart of claim 16, wherein the wheeled platform further includes a handle attached to the platform.

18. The lift cart of claim 1, wherein the wheeled platform is configured to support cargo.

19. The lift cart of claim 18, wherein the lift assembly is configured to raise the extension assembly and the wheeled platform when the wheeled platform is supporting cargo.

20. The lift cart of claim 1, further comprising a controller controllably coupled to the lift assembly to selectively activate the lift assembly to raise the extension assembly and the wheeled platform.
